(19) United States
(12) Patent Application Publication
(10) Pub. No.: US 2009/0094261 A1
(43) Pub. Date: Apr. 9, 2009

(54) Systems and methods for correlating epigenetic information with disability data

(76) Inventors: Edward K.Y. Jung, Bellevue, WA (US); Roderick A. Hyde, Redmond, WA (US); Jordin T. Kare, Seattle, WA (US); Eric C. Leuthardt, St. Louis, MO (US); Dennis J. Rivet, Portsmouth, VA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(21) Appl. No.: 12/004,098

(22) Filed: Dec. 19, 2007

Related U.S. Application Data
(63) Continuation-in-part of application No. 11/906,995, filed on Oct. 4, 2007.
Application No. 11/906,995 is a continuation-in-part of application No. 11/974,166, filed on Oct. 11, 2007.
Application No. 11/974,166 is a continuation-in-part of application No. 11/986,967, filed on Nov. 27, 2007.
Application No. 11/986,967 is a continuation-in-part of application No. 11/986,986, filed on Nov. 27, 2007.
Application No. 11/986,986 is a continuation-in-part of application No. 11/986,966, filed on Nov. 27, 2007.

(51) Int. Cl. G06F 17/30

(52) U.S. Cl. 707/100; 707/E17.005

(57) ABSTRACT

A method includes receiving epigenetic information associated with at least a first individual, receiving disability data associated with at least a second individual, and/or correlating the epigenetic information associated with at least a first individual with the disability data associated with at least a second individual.

A system includes means for receiving epigenetic information associated with at least a first individual, means for receiving disability data associated with at least a second individual, and means for correlating the epigenetic information associated with at least a first individual with the disability data associated with at least a second individual.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/906,995, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 4, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/974,166, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 11, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/986,967, entitled SYSTEMS AND METHODS FOR ANONYMIZING PERSONALLY IDENTIFIABLE INFORMATION ASSOCIATED WITH EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/986,986, entitled SYSTEMS AND METHODS FOR TRANSFERRING COMBINED EPIGENETIC INFORMATION AND OTHER INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/986,966, entitled SYSTEMS AND METHODS FOR REINSURANCE UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Nov. 27, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A method includes receiving epigenetic information associated with at least a first individual, receiving disability data associated with at least a second individual, and/or correlating the epigenetic information associated with at least a first individual with the disability data associated with at least a second individual. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein- referenced method aspects depending upon the design choices of the system designer.

A system includes means for receiving epigenetic information associated with at least a first individual, means for receiving disability data associated with at least a second individual, and means for correlating the epigenetic information associated with at least a first individual with the disability data associated with at least a second individual. In addition to the foregoing, other method aspects are described in the claims, drawings, and text forming a part of the present disclosure.

A system includes circuitry for receiving epigenetic information associated with at least a first individual, circuitry for receiving disability data associated with at least a second individual, and circuitry for correlating the epigenetic information associated with at least a first individual with the disability data associated with at least a second individual. In addition to the foregoing, other method aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1A illustrates an exemplary environment in which one or more technologies may be implemented.

FIG. 2 illustrates an operational flow representing example operations related to correlating epigenetic information associated with at least a first person with disability data associated with at least a second person.

FIG. 3 illustrates an alternative embodiment of the operational flow of FIG. 2.

FIG. 4 illustrates an alternative embodiment of the operational flow of FIG. 2.

FIG. 5 illustrates an alternative embodiment of the operational flow of FIG. 2.

FIG. 6 illustrates an alternative embodiment of the operational flow of FIG. 2.

FIG. 7 illustrates an alternative embodiment of the operational flow of FIG. 2.

FIG. 8 illustrates an alternative embodiment of the operational flow of FIG. 2.

FIG. 9 illustrates an alternative embodiment of the operational flow of FIG. 2.

FIG. 10 illustrates an alternative embodiment of the operational flow of FIG. 2.

FIG. 11 illustrates an alternative embodiment of the operational flow of FIG. 2.

FIG. 12 illustrates an alternative embodiment of the operational flow of FIG. 2.

FIG. 13 illustrates an alternative embodiment of the operational flow of FIG. 2.

FIG. 14 illustrates an alternative embodiment of the operational flow of FIG. 2.

FIG. 15 illustrates an alternative embodiment of the operational flow of FIG. 2.

FIG. 16 illustrates an alternative embodiment of the operational flow of FIG. 2.

FIG. 17 illustrates an alternative embodiment of the operational flow of FIG. 2.

FIG. 18 illustrates an alternative embodiment of the operational flow of FIG. 2.

FIG. 19 illustrates an alternative embodiment of the operational flow of FIG. 2.

FIG. 20 illustrates an alternative embodiment of the operational flow of FIG. 2.

FIG. 21 illustrates an alternative embodiment of the operational flow of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

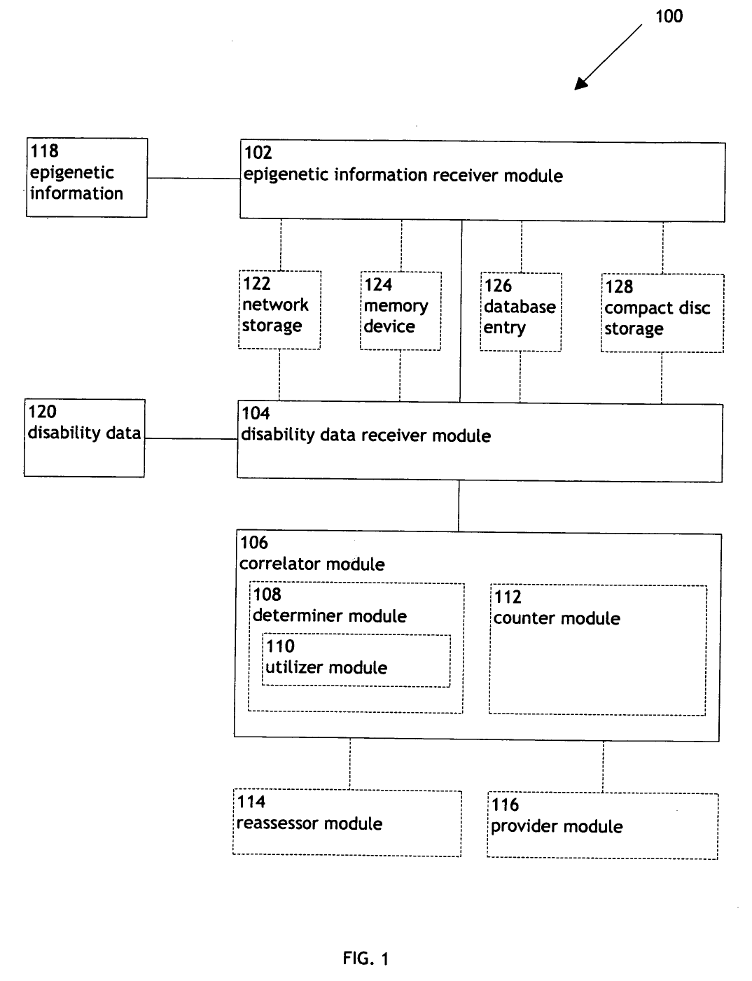

Referring to FIG. 1, a system 100 for correlating epigenetic information associated with at least a first person with disability data associated with at least a second person is illustrated. The system 100 may include epigenetic information receiver module 102, disability data receiver module 104, and/or correlator module 106. The system 100 may further include reassessor module 114 and/or provider module 116. Epigenetic information receiver module 102 may receive epigenetic information 118. Disability data receiver module 104 may receive disability data 120. Correlator module 106 may further include determiner module 108, and counter module 112. Determiner module 108 may further include utilizer module 110. System 100 generally represents instrumentality for correlating epigenetic information associated with at least a first person with disability data associated with at least a second person. Correlating epigenetic information associated with at least a first person with disability data associated with at least a second person may be accomplished electronically, such as with a set of interconnected electrical components, an integrated circuit, and/or a computer processor.

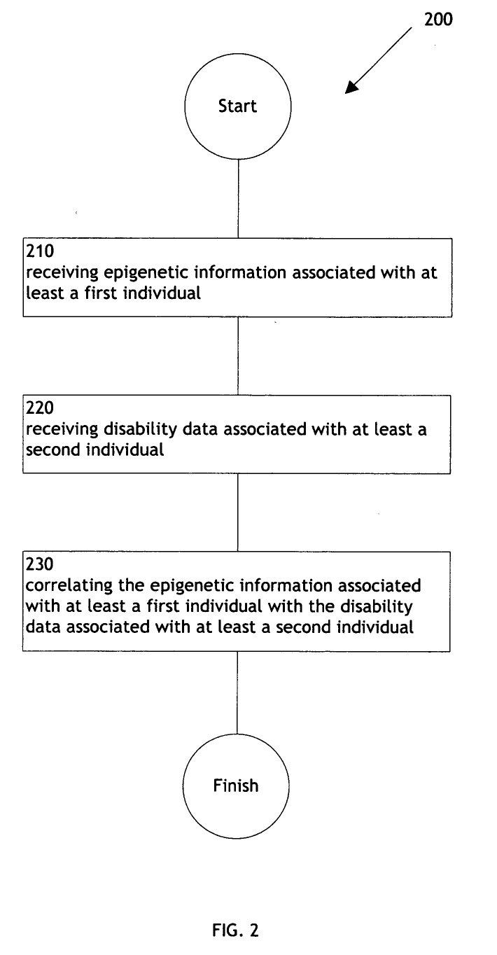

FIG. 2 illustrates an operational flow 200 representing example operations related to receiving epigenetic information associated with at least a first individual, receiving disability data associated with at least a second individual, and/or correlating the epigenetic information associated with at least a first individual with the disability data associated with at least a second individual. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200 moves to a receiving epigenetic information associated with at least a first individual operation 210, where epigenetic information associated with at least a first individual may be received. For example, as shown in FIG. 1, epigenetic information receiver module 102 may receive epigenetic information associated with a first individual. In one specific instance, epigenetic information receiver module 102 receives epigenetic information 118 associated with Robert Smith from memory device 124. In some instances, epigenetic information receiver module 102 may include a computer processor. Some explanation regarding epigenetic information 118 may be found in sources such as Bird, Perceptions of Epigenetics, NATURE 477, 396-398 (2007); Grewal and Elgin, Transcription and RNA Interference in the Formation of Heterochromatin, NATURE 447: 399-406 (2007); and Callinan and Feinberg, The Emerging Science of Epigenomics, HUMAN MOLECULAR GENETICS 15, R95-R11 (2006), each of which are incorporated herein by reference. Epigenetic information may include, for example, information regarding DNA methylation, histone states or modifications, transcriptional activity, RNAi, protein binding or other molecular states. Further, epigenetic information may include information regarding inflammation-mediated cytosine damage products. See, e.g., Valintuck and Sowers, Inflammation-Mediated Cytosine Damage: A Mechanistic Link Between Inflammation and the Epigenetic Alterations in Human Cancers, CANCER RESEARCH 67: 5583-5586 (2007), which is incorporated herein by reference.

Then, in a receiving disability data associated with at least a second individual operation 220, disability data associated with at least a second individual may be received. For example, as shown in FIG. 1, disability data receiver module 104 may receive disability data associated with at least a second individual. In one instance, disability data receiver module 104 receives disability data associated with at least a second individual named John Smith. In some instances, the first individual and the second individual may have a familial and/or a blood relationship. In some examples, disability data receiver module 104 may include a computer processor.

Then, in a correlating the epigenetic information associated with at least a first individual with the disability data associated with at least a second individual operation 230, the epigenetic information associated with at least a first individual with the disability data associated with at least a second individual may be correlated. For example, as shown in FIG. 1, correlator module 106 may correlate the epigenetic information associated with at least a first individual with the disability data associated with at least a second individual. In one instance and continuing from the examples above, correlator module 106 correlates epigenetic information regarding a histone structure modification associated with a first individual named Robert Smith with disability data regarding a disease associated with a second individual named John Smith. In some instances, correlator module 106 may include a computer processor.

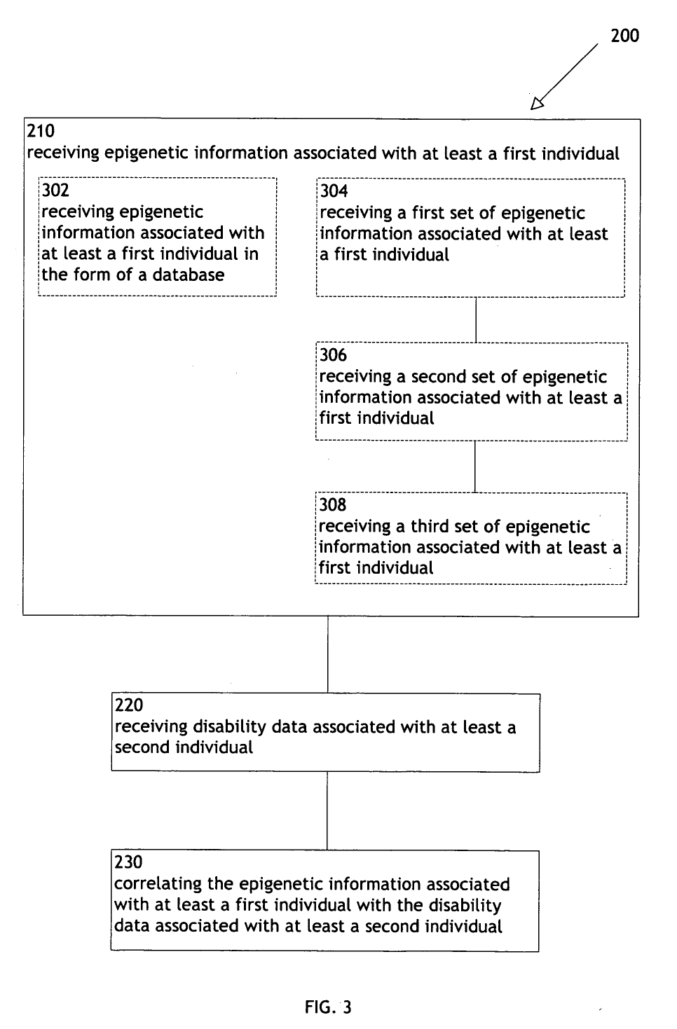

FIG. 3 illustrates alternative embodiments of the example operational flow 200 of FIG. 2. FIG. 3 illustrates example embodiments where the receiving epigenetic information associated with at least a first individual operation 210 may include at least one additional operation. Additional operations may include an operation 302, an operation 304, an operation 306, and/or an operation 308.

At the operation 302, epigenetic information associated with at least a first individual in the form of a database may be received. For example, as shown in FIG. 1, epigenetic information receiver module 102 may receive epigenetic information associated with at least a first individual in the form of a database. In one specific instance, epigenetic information receiver module 102 receives epigenetic information including a methylation at a specific DNA location in the form of a database from a database entry 126. A database may include a collection of data organized for convenient access. The database may include information digitally stored in a memory device 124, as at least a portion of at least one database entry 126, in compact disc storage 128, and/or in network storage 122. In some instances, the database may include information stored non-digitally such as at least a portion of a book, a paper file, and/or a non-computerized index and/or catalog. Non-computerized information may be received by epigenetic information receiver module 102 by scanning or manually entering the information into a digital format. In some instances, epigenetic information receiver module 102 may include a computer processor.

At the operation 304, a first set of epigenetic information associated with at least a first individual may be received. For example, as shown in FIG. 1, epigenetic information receiver module 102 may receive a first set of epigenetic information associated with at least a first individual. In one specific instance, epigenetic information receiver module 102 receives from network storage 122 a first set of epigenetic information regarding DNA methylation at specific loci associated with at least a first individual named Ron Smith. A set of information may include a set amount of information and both terms may be used interchangeably herein. Further, a set of information may include batch, finite, and/or discrete amounts information. Additionally, epigenetic information may be received for more than one individual. In some instances, epigenetic information receiver module 102 may include a computer processor. Then, at the operation 306, a second set of epigenetic information associated with at least a first individual may be received. For example, as shown in FIG. 1, epigenetic information receiver module 102 may receive a second set of epigenetic information associated with at least a first individual. In one specific instance, epigenetic information receiver module 102 receives from network storage 122 a second set of epigenetic information regarding DNA methylation at specific loci associated with an individual named Ron Smith. Additionally, epigenetic information may be received for more than one individual, such as a group of five thousand individuals. In some instances, epigenetic information receiver module 102 may include a computer processor. Further, at the operation 308, a third set of epigenetic information associated with at least a first individual may be received. For example, as shown in FIG. 1, epigenetic information receiver module 102 may receive a third set of epigenetic information associated with at least a first individual. In one instance and continuing with the example above, epigenetic information receiver module 102 receives from memory device 124 a third set of epigenetic information indicating an increased likelihood of heart disease associated with at least a first individual named Ron Smith. Additionally, epigenetic information may be received for more than one individual, such as a group of one thousand individuals. In some instances, epigenetic information receiver module 102 may include a computer processor. Additional sets of information may be received by epigenetic information receiver module 102 as batches or finite sets beyond the first, second, and third set of epigenetic information.

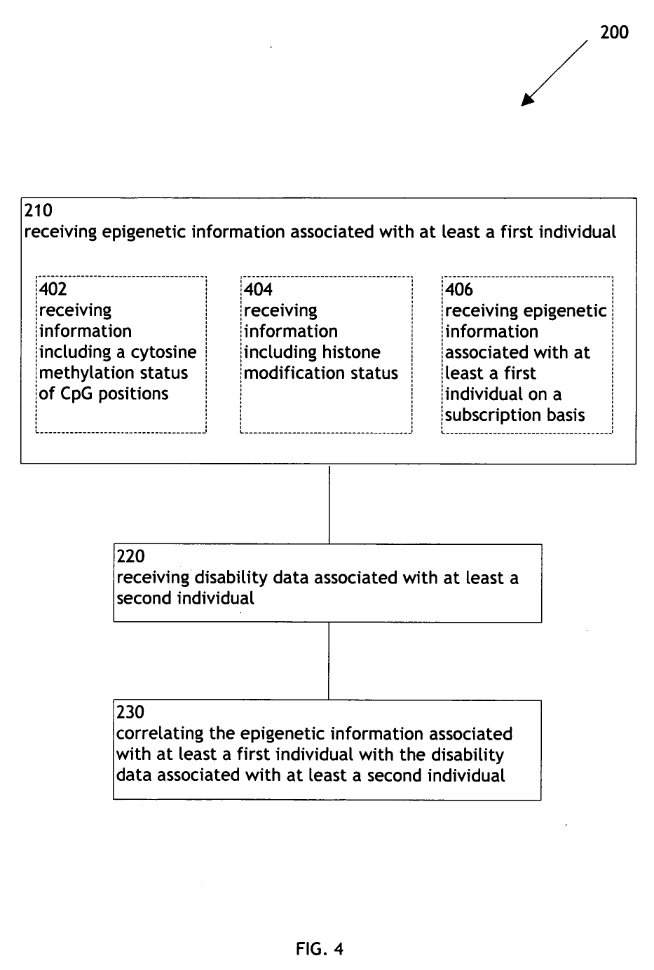

FIG. 4 illustrates alternative embodiments of the example operational flow 200 of FIG. 2. FIG. 4 illustrates example embodiments where the receiving epigenetic information associated with at least a first individual operation 210 may include at least one additional operation. Additional operations may include an operation 402, an operation 404, and/or an operation 406.

At the operation 402, receiving information including a cytosine methylation status of CpG positions may be received. For example, as shown in FIG. 1, epigenetic information receiver module 102 may accept information including a cytosine methylation status of CpG positions. In one specific example, epigenetic information receiver module 102 accepts from memory device 124 information regarding a specific cytosine methylation status of CpG positions. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference. In some instances, epigenetic information receiver module 102 may include a computer processor.

At the operation 404, information including histone modification status may be received. For example, as shown in FIG. 1, epigenetic information receiver module 102 may receive information including histone modification status. In a specific instance, epigenetic information receiver module 102 receives from compact disc storage 128 information including histone modification status for a group of one hundred individuals. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference. In some instances, epigenetic information receiver module 102 may include a computer processor.

At the operation 406, epigenetic information associated with at least a first individual on a subscription basis may be received. For example, as shown in FIG. 1, epigenetic information receiver module 102 may receive epigenetic information associated with at least a first individual on a subscription basis. In a specific instance, epigenetic information receiver module 102 receives from network storage 122 epigenetic information indicating a decreased likelihood of developing lung cancer associated with an individual named George Benson on a subscription basis for six months. A subscription may include an agreement to receive and/or be given access to the epigenetic information. The subscription may include access to epigenetic information in a digital form and/or a physical form of information, such as paper printouts. In some instances, epigenetic information receiver module 102 may include a computer processor.

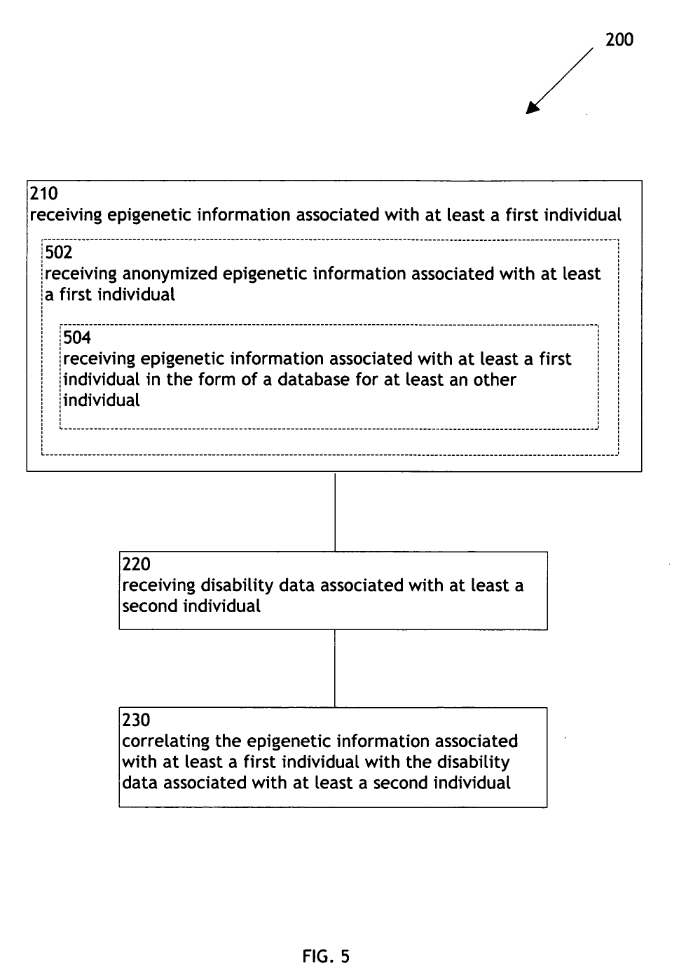

FIG. 5 illustrates alternative embodiments of the example operational flow 200 of FIG. 2. FIG. 5 illustrates example embodiments where the receiving epigenetic information associated with at least a first individual operation 210 may include at least one additional operation. Additional operations may include an operation 502, and/or an operation 504.

At the operation 502, anonymized epigenetic information associated with at least a first individual may be received. For example, as shown in FIG. 1, epigenetic information receiver module 102 may receive anonymized epigenetic information associated with at least a first individual. In one specific example, epigenetic information receiver module 102 receives anonymized epigenetic information associated with an individual named Thomas Brown indicating a likelihood of diabetes. In the present example, epigenetic information receiver module 102 receives anonymized epigenetic information including Thomas Brown's epigenetic information for a specific DNA methylation and/or histone structure, where Thomas Brown is an example of at least a first individual, and the epigenetic information associated with Thomas Brown indicates a probability whether Thomas Brown will develop diabetes at a predetermined age. In some instances, epigenetic information receiver module 102 may include a computer processor. Additionally, anonymized epigenetic information may be received for more than one individual, such as a group of two hundred individuals. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. Further, at the operation 504, epigenetic information for at least an other individual may be received in the form of a database. For example, as shown in FIG. 1, epigenetic information receiver module 102 may receive epigenetic information for at least an other individual in the form of a database. In one specific instance, epigenetic information receiver module 102 receives from memory device 124 epigenetic information for at least an other individual named Robert Green regarding a specific histone structure modification, the epigenetic information in the form of a database. The first individual may or may not have a familial and/or blood relationship. In some instances, epigenetic information receiver module 102 may include a computer processor.

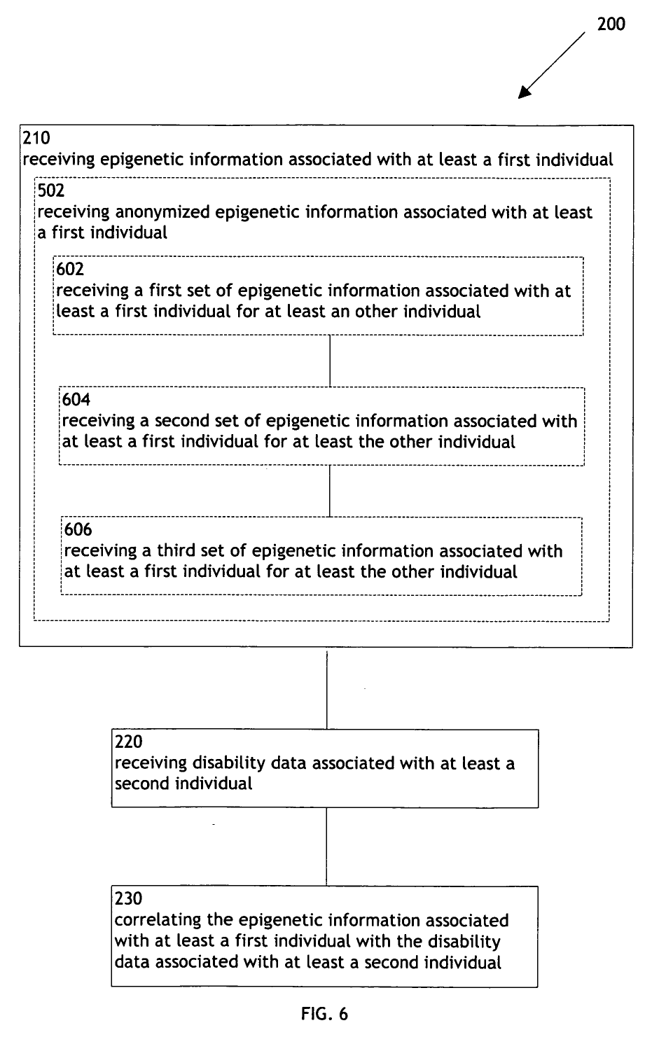

FIG. 6 illustrates alternative embodiments of the example operational flow 200 of FIG. 2. FIG. 6 illustrates example embodiments where the receiving epigenetic information associated with at least a first individual operation 210 may include at least one additional operation. Additional operations may include an operation 602, an operation 604, and/or an operation 606. Further, at the operation 602, a first set of epigenetic information may be received for at least an other individual. For example, as shown in FIG. 1, epigenetic information receiver module 102 may receive a first set of epigenetic information for at least an other individual. In one specific example, epigenetic information receiver module 102 receives from a database entry 126 a first set of epigenetic information for a group of two hundred other individuals indicating a certain methylation at a specific DNA location. In some instances, epigenetic information receiver module 102 may include a computer processor. Then, at the operation 604, a second set of epigenetic information may be received for at least the other individual. For example, as shown in FIG. 1, epigenetic information receiver module 102 may receive a second set of epigenetic information for at least the other individual. In one specific instance and continuing from the example above, epigenetic information receiver module 102 receives from compact disc storage 128 a second set of epigenetic information for a group of two hundred other individuals indicating a certain methylation at a specific DNA location. In some instances, epigenetic information receiver module 102 may include a computer processor. Further, at the operation 606, a third set of epigenetic information may be received for at least the other individual. For example, as shown in FIG. 1, epigenetic information receiver module 102 may receive a third set of epigenetic information for at least the other individual. In a specific instance and continuing with the example above, epigenetic information receiver module 102 receives from memory device 124 a third set of epigenetic information for a group of two hundred other individuals indicating a certain methylation at a specific DNA location. A set of information may include a set amount of information and both terms may be used interchangeably herein. Further, a set of information may include batch, finite, and/or discrete amounts information. Additionally, epigenetic information may be received for more than one individual. In some instances, epigenetic information receiver module 102 may include a computer processor.

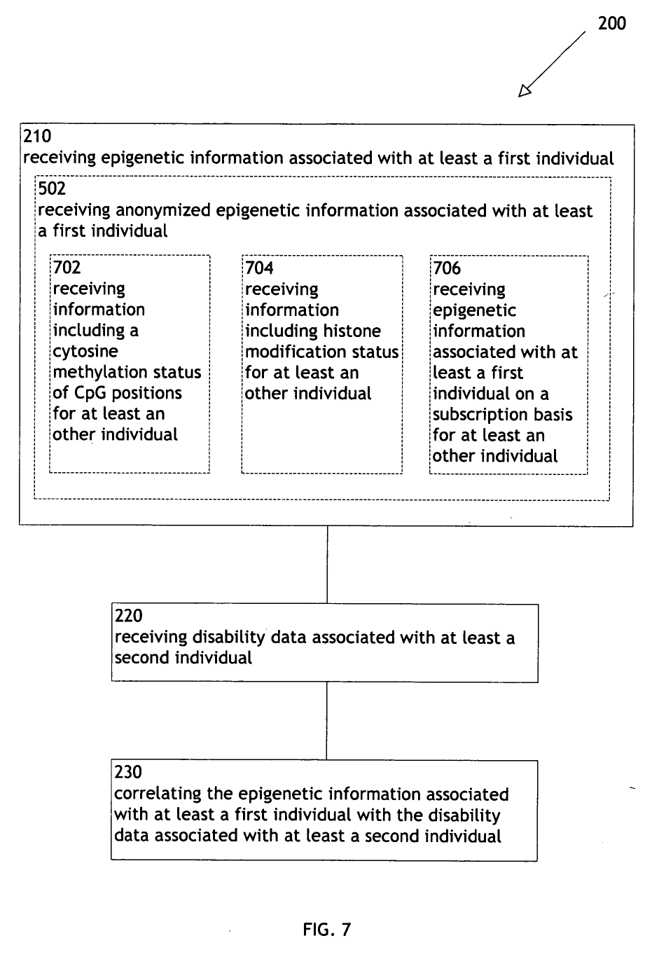

FIG. 7 illustrates alternative embodiments of the example operational flow 200 of FIG. 2. FIG. 7 illustrates example embodiments where the receiving epigenetic information associated with at least a first individual operation 210 may include at least one additional operation. Additional operations may include an operation 702, an operation 704, and/or an operation 706. Further, at the operation 702, information including a cytosine methylation status of CpG positions may be received for at least an other individual. For example, as shown in FIG. 1, epigenetic information receiver module 102 may receive information for at least an other individual, the information including a cytosine methylation status of CpG positions. In a specific example, epigenetic information receiver module 102 receives from a database entry 126 information for a group of fifty individual separate from the first individual, the information including a cytosine methylation status of CpG positions. In some instances, epigenetic information receiver module 102 may include a computer processor. Further, at the operation 704, information including histone modification status may be received for at least an other individual. For example, as shown in FIG. 1, epigenetic information receiver module 102 may receive information for at least an other individual, the information including histone modification status. In one instance, epigenetic information receiver module 102 receives information for a group of one hundred people living in the same vicinity, the information including a specific histone modification status. In some instances, epigenetic information receiver module 102 may include a computer processor. Further, at the operation 706, epigenetic information may be received for at least an other individual on a subscription basis. For example, as shown in FIG. 1, epigenetic information receiver module 102 may receive epigenetic information for at least an other individual on a subscription basis. In a specific example, epigenetic information receiver module 102 receives from compact disc storage 128 epigenetic information for a group of twenty individuals on a subscription basis for one year, where the epigenetic information indicates a likelihood of developing skin cancer and where the twenty individuals have the same great grandfather as the first individual. A subscription may include an agreement to receive and/or be given access to the epigenetic information. The subscription may include access to epigenetic information in a digital form and/or a physical form of information, such as paper printouts. In some instances, epigenetic information receiver module 102 may include a computer processor.

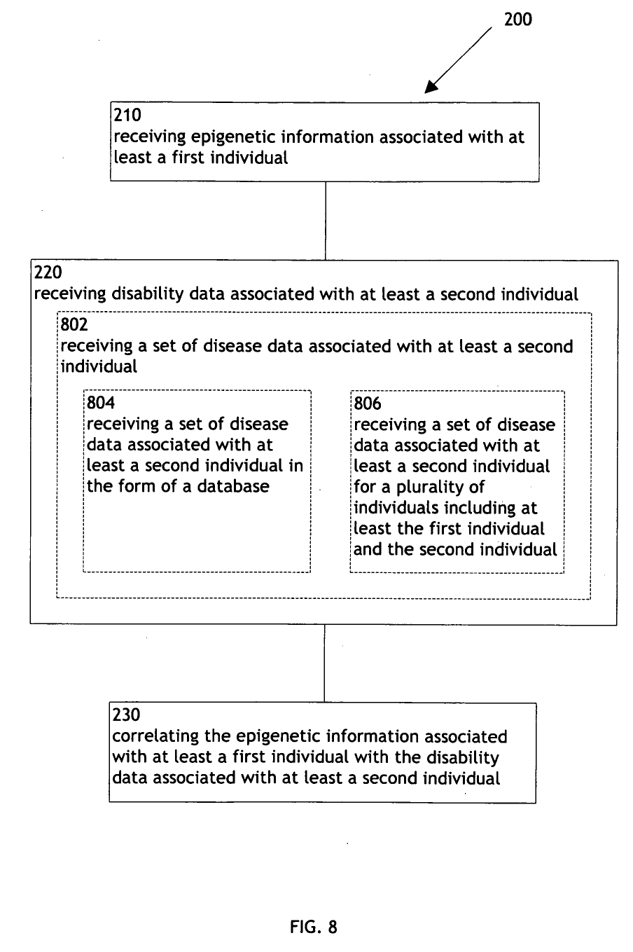

FIG. 8 illustrates alternative embodiments of the example operational flow 200 of FIG. 2. FIG. 8 illustrates example embodiments where the receiving disability data associated with at least a second individual operation 220 may include at least one additional operation. Additional operations may include an operation 802, an operation 804, and/or an operation 806.

At the operation 802, a set of disease data associated with at least a second individual may be received. For example, as shown in FIG. 1, disability data receiver module 104 may receive a set of disease data associated with at least a second individual. In one instance, disability data receiver module 104 may receive from memory device 124 a set of disease data associated with a second individual, named Steve Larsen, separate from a first individual named Greg Larsen. In some instances, disability data receiver module 104 may include a computer processor. Further, at the operation 804, a set of disease data associated with at least a second individual in the form of a database may be received. For example, as shown in FIG. 1, disability data receiver module 104 may receive a set of disease data associated with at least a second individual named Steve Larsen in the form of a database. In a specific example, disability data receiver module 104 receives from network storage 122 a set of disease data associated with at least a second individual in the form of a database, the second individual being different from the first individual. In some instances, a database may include information stored non-digitally such as at least a portion of a book, a paper file, and/or a non-computerized index and/or catalog. Non-computerized information may be received by disability data receiver module 104 by scanning or manually entering the information into a digital format. In some instances, disability data receiver module 104 may include a computer processor. Further, at the operation 806, a set of disease data associated with at least a second individual for a plurality of individuals including at least the first individual and the second individual may be received. For example, as shown in FIG. 1, disability data receiver module 104 may receive a set of disease data associated with at least a second individual for a plurality of individuals including at least the first individual and the second individual. In one specific instance and continuing with the example above, disability data receiver module 104 receives a set of disease data regarding hypertension associated with a second individual named Steve Larsen for a plurality of individuals including at least the first individual named Greg Larsen, the second individual named Steve Larsen, and a group of twenty blood relatives of Steve Larsen and Greg Larsen. In some instances, disability data receiver module 104 may include a computer processor.

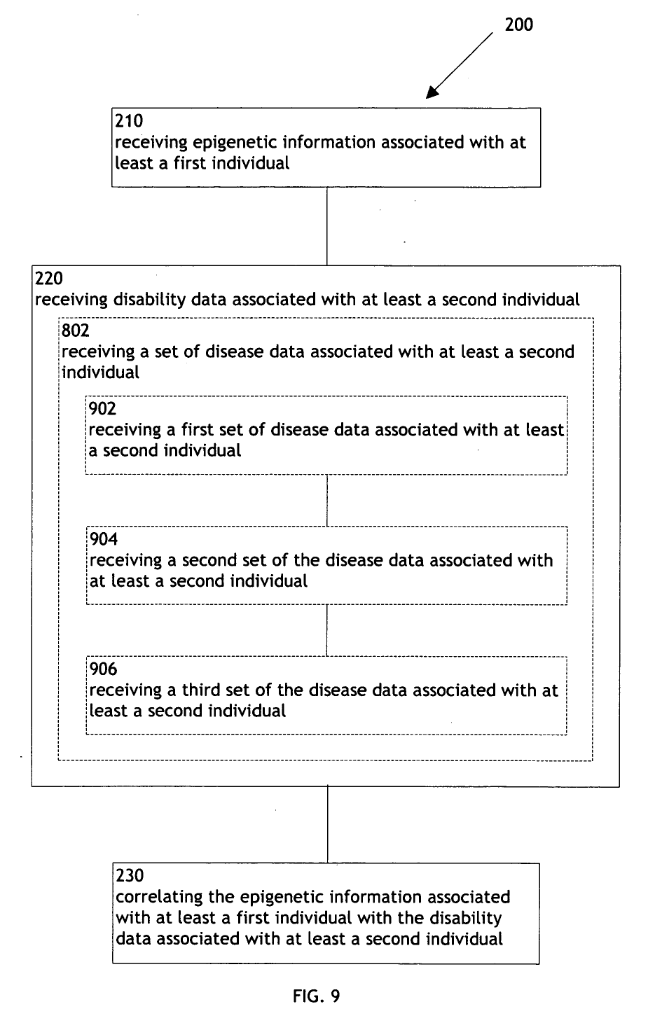

FIG. 9 illustrates alternative embodiments of the example operational flow 200 of FIG. 2. FIG. 9 illustrates example embodiments where the receiving disability data associated with at least a second individual operation 220 may include at least one additional operation. Additional operations may include an operation 902, an operation 904, and/or an operation 906. Further, at the operation 902, a first set of disease data associated with at least a second individual may be received. For example, as shown in FIG. 1, disability data receiver module 104 may receive a first set of disease data associated with at least a second individual. In a specific instance, disability data receiver module 104 receives a first set of disease data associated with a second individual named David Newman. Disease data may be received for individuals in addition to the second individual. In some instances, disability data receiver module 104 may include a computer processor. Then, at the operation 904, a second set of the disease data associated with at least a second individual may be received. For example, as shown in FIG. 1, disability data receiver module 104 may receive a second set of the disease data associated with at least a second individual. In one instance and continuing with the example above, disability data receiver module 104 receives a second set of the disease data associated with a second individual named David Newman. Disease data may be received for individuals in addition to the second individual. In some instances, disability data receiver module 104 may include a computer processor. Further, at the operation 906, a third set of the disease data associated with at least a second individual may be received. For example, as shown in FIG. 1, disability data receiver module 104 may receive a third set of the disease data associated with at least a second individual. In one instance and continuing with the example above, disability data receiver module 104 receives a third set of the disease data from compact disc storage 128 associated with a second individual named David Newman. Disease data may be received for individuals in addition to the second individual. In some instances, disability data receiver module 104 may include a computer processor. Additional sets of information may be received by disability data receiver module 104 as batches or finite sets beyond the first, second, and third set of disease data.

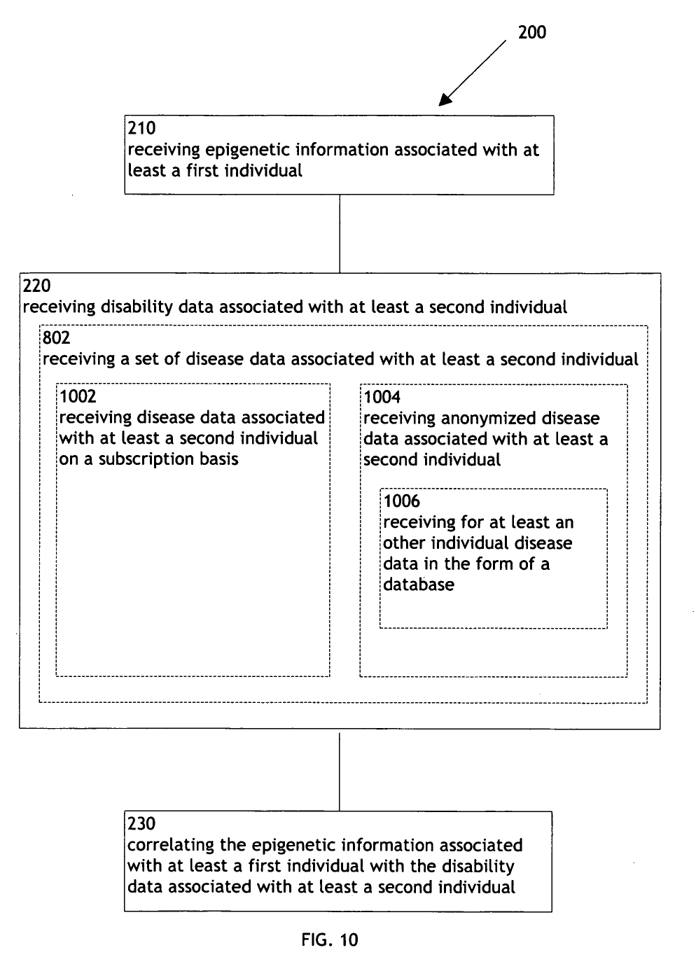

FIG. 10 illustrates alternative embodiments of the example operational flow 200 of FIG. 2. FIG. 10 illustrates example embodiments where the receiving disability data associated with at least a second individual operation 220 may include at least one additional operation. Additional operations may include an operation 1002, an operation 1004, and/or an operation 1006. Further, at the operation 1002, disease data associated with at least a second individual on a subscription basis may be received. For example, as shown in FIG. 1, disability data receiver module 104 may receive disease data associated with at least a second individual on a subscription basis. In one specific instance, disability data receiver module 104 receives disease data from a database entry 126 associated with a second individual named Tom Smith on a subscription basis for five years. A subscription may include an agreement to receive and/or be given access to the epigenetic information. The subscription may include access to disease information in a digital form and/or a physical form of information, such as paper printouts. In some instances, disability data receiver module 104 may include a computer processor. Further, at the operation 1004, receiving anonymized disease data associated with at least a second individual may be received. For example, as shown in FIG. 1, disability data receiver module 104 may receive anonymized disease data associated with at least a second individual. In one example and continuing from above, disability data receiver module 104 receives anonymized disease data associated with a second individual named Tom Smith. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, disability data receiver module 104 may include a computer processor. Further, at the operation 1006, disease data associated with at least a second individual in the form of a database for at least an other individual may be received. For example, as shown in FIG. 1, disability data receiver module 104 may receive disease data associated with at least a second individual in the form of a database. In a specific instance and continuing from above, disability data receiver module 104 receives from network storage 122 disease data associated with a second individual named Tom Smith in the form of a database. A database may include a collection of data organized for convenient access. The database may include information digitally stored in a memory device 124, as at least a portion of at least one database entry 126, in compact disc storage 128, and/or in network storage 122. In some instances, the database may include information stored non-digitally such as at least a portion of a book, a paper file, and/or a non-computerized index and/or catalog. Non-computerized information may be received by disability data receiver module 104 by scanning or manually entering the information into a digital format. In some instances, disability data receiver module 104 may include a computer processor.

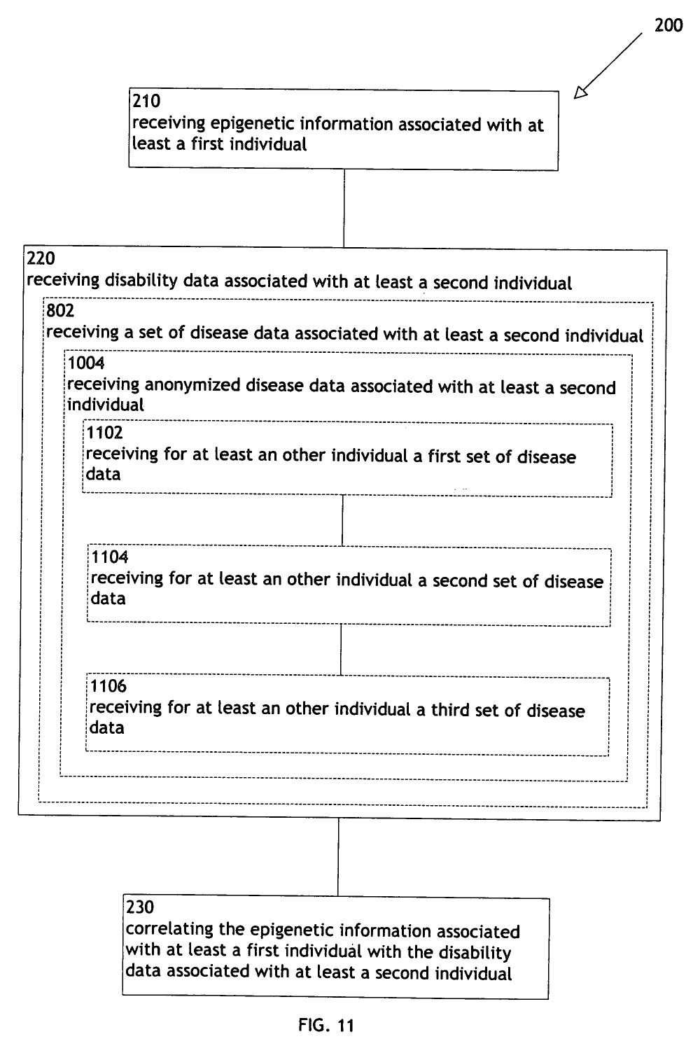

FIG. 11 illustrates alternative embodiments of the example operational flow 200 of FIG. 2. FIG. 11 illustrates example embodiments where the receiving disability data associated with at least a second individual operation 220 may include at least one additional operation. Additional operations may include an operation 1102, an operation 1104, and/or an operation 1106. Further, at the operation 1102, a first set of disease data associated with at least a second individual for at least an other individual may be received. For example, as shown in FIG. 1, disability data receiver module 104 may receive a first set of disease data associated with at least a second individual for at least an other individual. In a specific instance, disability data receiver module 104 receives from memory device 124 a first set of disease data associated with a second individual named Michael Thomas and an other individual named Charles Thomas. The second individual and the other individual may or may not have a familial and/or blood relationship. Further, disease data may be received for multiple individuals in addition to the second individual an the other individual. In some instances, disability data receiver module 104 may include a computer processor. Then, at the operation 1104, a second set of disease data associated with at least a second individual for at least the other individual may be received. For example, as shown in FIG. 1, disability data receiver module 104 may receive a second set of disease data associated with at least a second individual for at least an other individual. In a specific instance and continuing with the example above, disability data receiver module 104 receives from memory device 124 a second set of disease data associated with a second individual named Michael Thomas and an other individual named Charles Thomas. The second individual and the other individual may or may not have a familial and/or blood relationship. Further, disease data may be received for multiple individuals in addition to the second individual and the other individual. In some instances, disability data receiver module 104 may include a computer processor. Further, at the operation 1106, a third set of disease data associated with at least a second individual for at least the other individual may be received. For example, as shown in FIG. 1, disability data receiver module 104 may receive a third set of disease data associated with at least a second individual for at least an other individual. In a specific instance and continuing with the example above, disability data receiver module 104 receives from memory device 124 a third set of disease data associated with a second individual named Michael Thomas and an other individual named Charles Thomas. The second individual and the other individual may or may not have a familial and/or blood relationship. Further, disease data may be received for multiple individuals in addition to the second individual and the other individual. In some instances, disability data receiver module 104 may include a computer processor. A set of information may include a set amount of information and both terms may be used interchangeably herein. Additional sets of information may be received by disability data receiver module 104 as batches or finite sets beyond the first, second, and third set of epigenetic information.

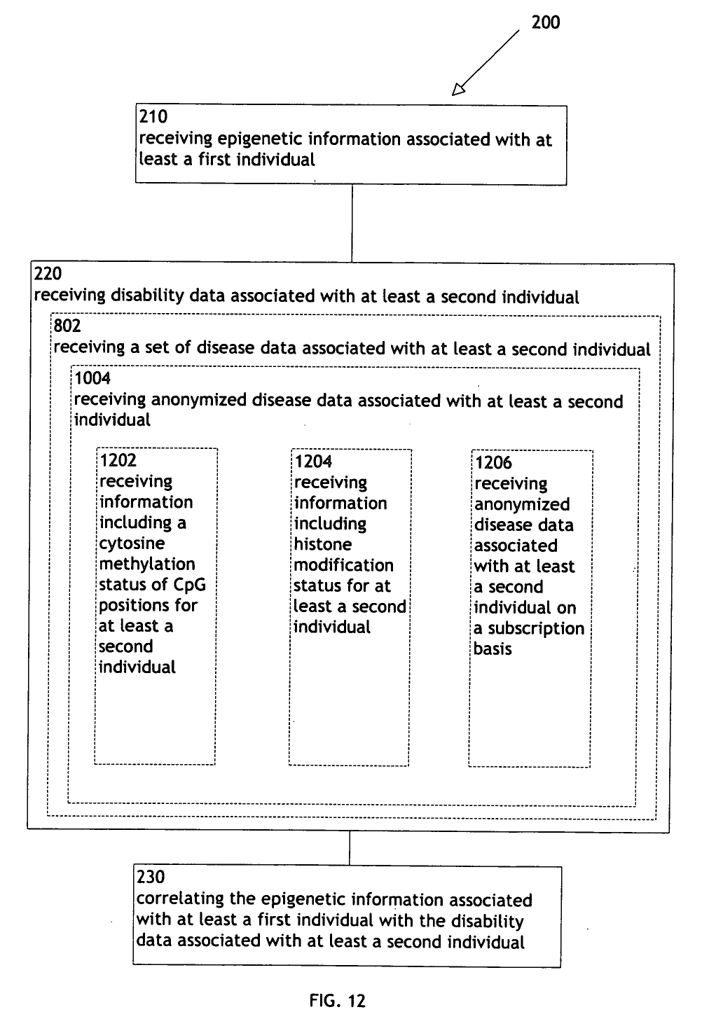

FIG. 12 illustrates alternative embodiments of the example operational flow 200 of FIG. 2. FIG. 12 illustrates example embodiments where the receiving disability data associated with at least a second individual operation 220 may include at least one additional operation. Additional operations may include an operation 1202, an operation 1204, and/or an operation 1206. Further, at the operation 1202, information including a cytosine methylation status of CpG positions may be received for at least a second individual. For example, as shown in FIG. 1, disability data receiver module 104 may receive information including a cytosine methylation status of CpG positions for at least a second individual. In one instance, disability data receiver module 104 receives from memory device 124 information including a cytosine methylation status of CpG positions may be received for a second individual named Nathan Thomas. In some instances, disability data receiver module 104 may include a computer processor. Further, at the operation 1204, information including histone modification status for at least a second individual may be received. For example, as shown in FIG. 1, disability data receiver module 104 may receive information including histone modification status for at least a second individual. In one instance, disability data receiver module 104 receives from memory device 124 information including histone modification status for at least a second individual named Tom Black. In some instances, disability data receiver module 104 may include a computer processor. Further, at the operation 1206, anonymized disease data associated with at least a second individual on a subscription basis may be received. For example, as shown in FIG. 1, disability data receiver module 104 may receive anonymized disease data associated with at least a second individual on a subscription basis. In one instance, disability data receiver module 104 receives from memory device 124 anonymized disease data associated with a second individual named Isaac Jones on a subscription basis. Additionally, anonymized disease data may be received for more than one individual, such as a group of two hundred individuals. Anonymized disease data may be anonymized in different degrees and by different methods. Different degrees of anonymization may include full anonymization and/or partial anonymization, such as in the case of pseudonym utilization. Methods for anonymizing disease data may include the use of cell suppression and/or utilizing anonymization algorithms. A subscription may include an agreement to receive and/or be given access to the epigenetic information. The subscription may include access to epigenetic information in a digital form and/or a physical form of information, such as paper printouts. In some instances, disability data receiver module 104 may include a computer processor.

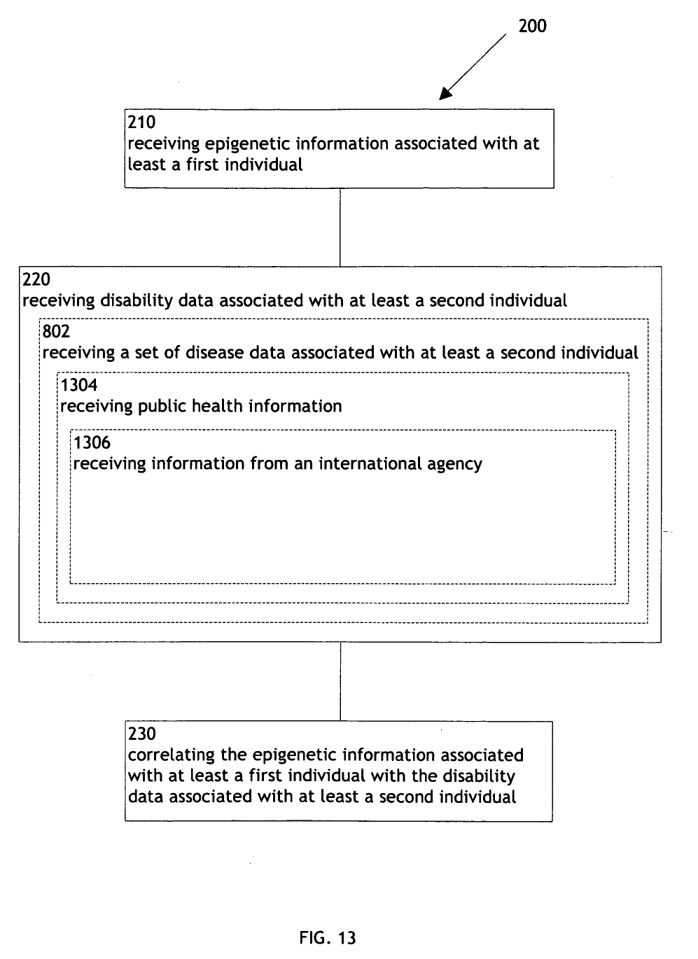

FIG. 13 illustrates alternative embodiments of the example operational flow 200 of FIG. 2. FIG. 13 illustrates example embodiments where the receiving disability data associated with at least a second individual operation 220 may include at least one additional operation. Additional operations may include an operation 1304 and/or an operation 1306. Further, at the operation 1304, public health information may be received. For example, as shown in FIG. 1, disability data receiver module 104 may receive public health information. In one instance, disability data receiver module 104 receives from database entry 126 public health information. In some instances, disability data receiver module 104 may include a computer processor. Further, at the operation 1306, information from an international agency may be received. For example, as shown in FIG. 1, disability data receiver module 104 may receive from database entry 126 information from an international agency. In a specific instance, disability data receiver module 104 receives from database entry 126 information from the World Health Organization (WHO). Other international agencies may include the World Bank, the United Nations, the Pan American Health Organization (PAHO), the United Nations Childrens Fund (UNICEF), the United Nation Development Programme (UNDP), Oxfam, and/or Project Hope, as well as other international agencies and organizations. In some instances, disability data receiver module 104 may include a computer processor.

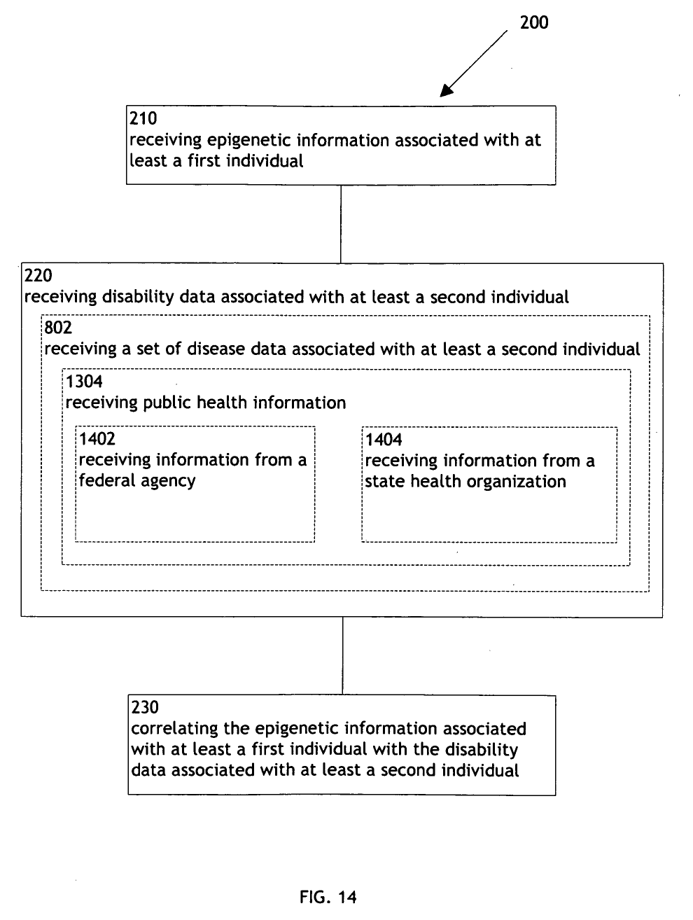

FIG. 14 illustrates alternative embodiments of the example operational flow 200 of FIG. 2. FIG. 14 illustrates example embodiments where the receiving disability data associated with at least a second individual operation 220 may include at least one additional operation. Additional operations may include an operation 1402, and/or an operation 1404. Further, at the operation 1402, information from a federal agency may be received. For example, as shown in FIG. 1, disability data receiver module 104 may receive information from a federal agency. In a specific instance, disability data receiver module 104 receives from database entry 126 information from the Centers for Disease Control and Prevention (CDC). Additional federal agencies may include the United States Department for Health and Human Services (HHS), the Office of Public Health and Science, the Office of the Surgeon General, and/or the United States Department for Veterans Affairs. In some instances, disability data receiver module 104 may include a computer processor. Further, at the operation 1404, information from a state health organization may be received. For example, as shown in FIG. 1, disability data receiver module 104 may receive information from a state health organization. In one instance, disability data receiver module 104 receives from network storage 122 information from a state health organization. A state health organization may include a state sponsored organization and/or agency as well as an organization representing the health interests of multiple states. In some instances, disability data receiver module 104 may include a computer processor.

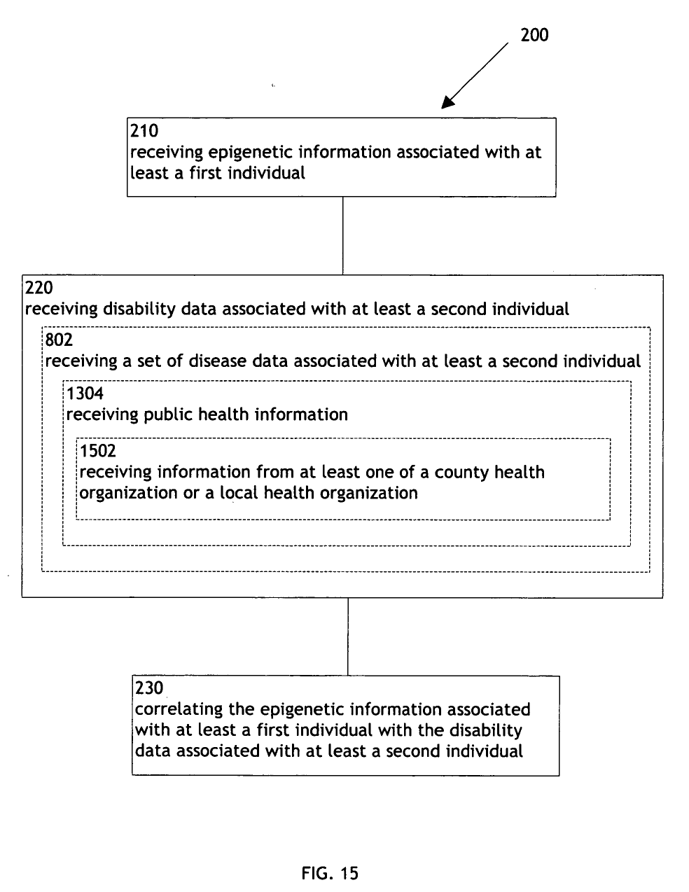

FIG. 15 illustrates alternative embodiments of the example operational flow 200 of FIG. 2. FIG. 15 illustrates example embodiments where the receiving disability data associated with at least a second individual operation 220 may include at least one additional operation. Additional operations may include an operation 1502. Further, at the operation 1502, information from at least one of a county health organization or a local health organization may be received. For example, as shown in FIG. 1, disability data receiver module 104 may receive information from at least one of a county health organization or a local health organization. In a specific example, disability data receiver module 104 receives from a database entry 126 information from at least one of a county health organization or a local health organization. A county health organization and/or a local health organization may include a county sponsored organization, a city sponsored organization, not for profit organizations, non-governmental organization, and/or an area sponsored organization. In some instances, disability data receiver module 104 may include a computer processor.

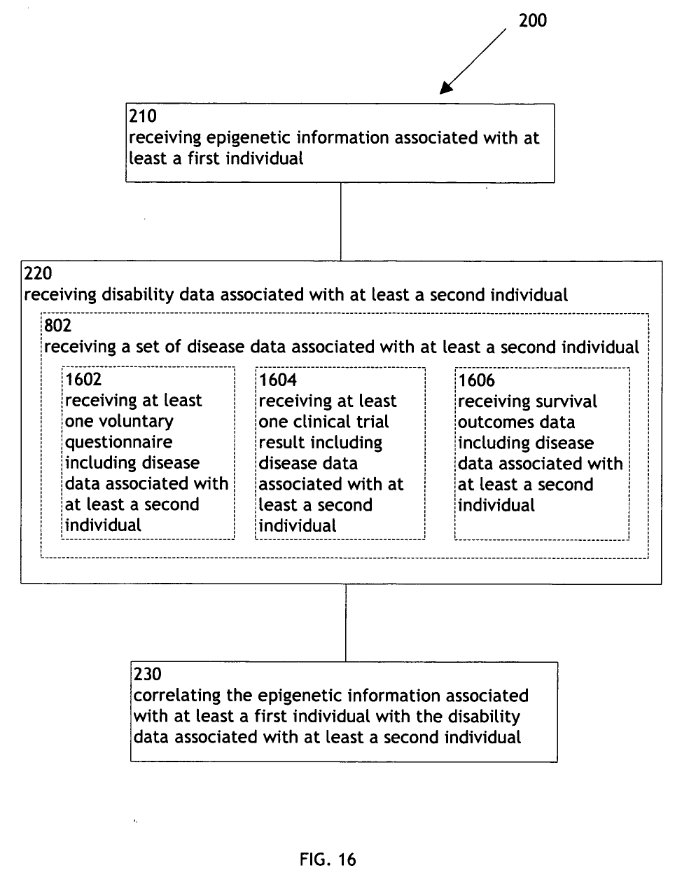

FIG. 16 illustrates alternative embodiments of the example operational flow 200 of FIG. 2. FIG. 16 illustrates example embodiments where the receiving disability data associated with at least a second individual operation 220 may include at least one additional operation. Additional operations may include an operation 1602, an operation 1604, and/or an operation 1606. Further, at the operation 1602, at least one voluntary questionnaire including disease data associated with at least a second individual may be received. For example, as shown in FIG. 1, disability data receiver module 104 may receive at least one voluntary questionnaire including disease data associated with at least a second individual. In a specific example, disability data receiver module 104 receives from memory device 124 a batch of ten thousand voluntary questionnaires including disease data associated with a group of ten thousand people including a second individual different than the first individual. Voluntary questionnaires may include questionnaires including medical information, epigenetic information, and disability information as well as other information. In some instances, disability data receiver module 104 may include a computer processor. Further, at the operation 1604, at least one clinical trial result including disease data associated with at least a second individual may be received. For example, as shown in FIG. 1, disability data receiver module 104 may receive at least one clinical trial result including disease data associated with at least a second individual. In one instance, disability data receiver module 104 receives from compact disc storage 128 a clinical trial result including disease data associated with a second individual named Tom Baker. A clinical trial result may include a result from a series of research studies using a limited number of patients. In some instances, disability data receiver module 104 may include a computer processor. Further, at the operation 1606, survival outcomes data including disease data associated with at least a second individual may be received. For example, as shown in FIG. 1, disability data receiver module 104 may receive survival outcomes data including disease data associated with at least a second individual. In a specific instance and continuing with the previous example, disability data receiver module 104 receives from network storage 122 survival outcomes data including disease data associated with at least a second individual named Tom Baker. Survival outcomes data may include data showing the amount of people with a certain disease who survive for a specific amount of time. The data may measure time for diagnosis and/or from receiving a specific treatment. Survival outcomes data may include results from other responses to treatment, such as quality of life and/or side effects. In some instances, disability data receiver module 104 may include a computer processor.

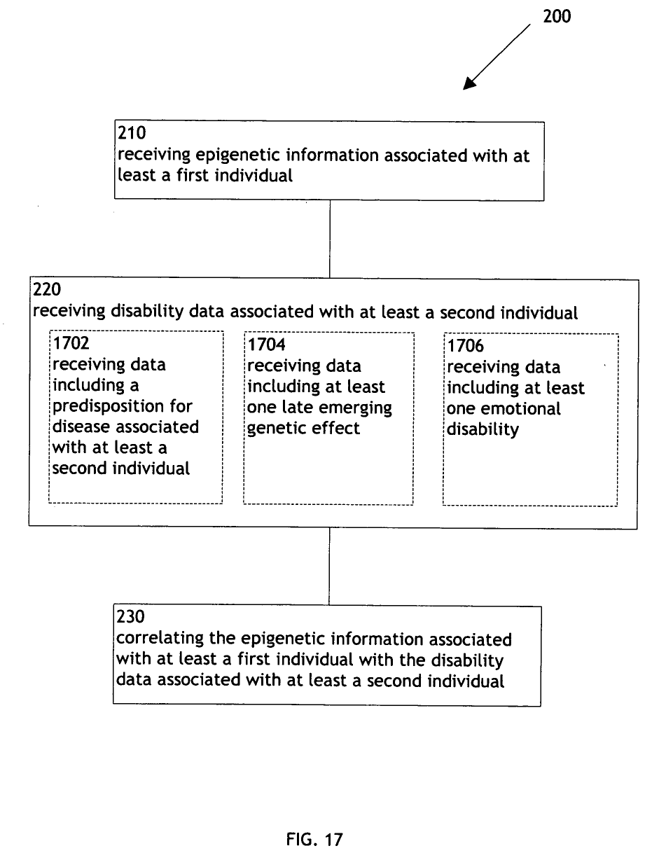

FIG. 17 illustrates alternative embodiments of the example operational flow 200 of FIG. 2. FIG. 17 illustrates example embodiments where the receiving disability data associated with at least a second individual operation 220 may include at least one additional operation. Additional operations may include an operation 1702, an operation 1704, and/or an operation 1706.

At the operation 1702, receiving data including a predisposition for disease associated with at least a second individual may be received. For example, as shown in FIG. 1, disability data receiver module 104 may receive data including a predisposition for disease associated with at least a second individual. In one specific instance, disability data receiver module 104 receives from memory device 124 data including a predisposition for disease associated with a second individual named Bob Harper, the second individual being separate from a first individual. A predisposition for disease may include a tendency to a condition or quality and may be based on the combined effects of epigenetics, genetics, and/or other environmental factors. In some instances, disability data receiver module 104 may include a computer processor.

At the operation 1704, data including at least one late emerging genetic effect may be received. For example, as shown in FIG. 1, disability data receiver module 104 may receive data including at least one late emerging genetic effect. In a specific instance, disability data receiver module 104 receives from database entry 126 data including a late emerging genetic effect including a disposition for Parkinson's disease. A late emerging effect may include effects, occurring after a certain period of time not having the effect, resulting from genetic, epigenetic, environmental, and/or other factors. The effects may include disease, illness, side reactions, physical disability, emotional disability, mental disability, and/or other types of impairment. In some instances, disability data receiver module 104 may include a computer processor.

At the operation 1706, data including at least one emotional disability may be received. For example, as shown in FIG. 1, disability data receiver module 104 may receive data including at least one emotional disability. In one instance, disability data receiver module 104 receives from network storage 122 data including an emotional disability. An emotional disability may include a condition that, over a certain time period and to a marked degree, consistently interferes with a learning ability. An emotional disability may often occur in children and/or adolescents. In some instances, disability data receiver module 104 may include a computer processor.

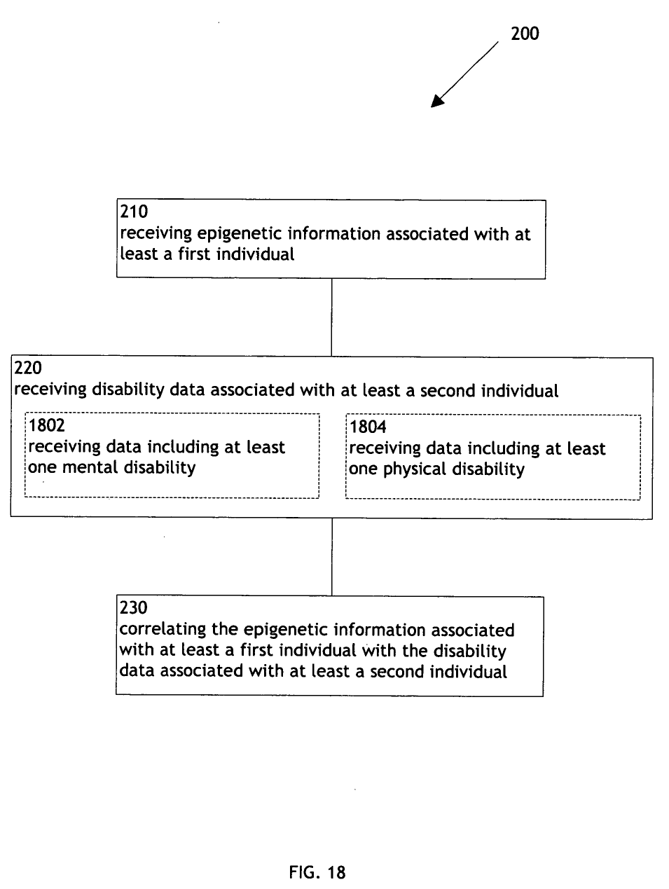

FIG. 18 illustrates alternative embodiments of the example operational flow 200 of FIG. 2. FIG. 18 illustrates example embodiments where the receiving disability data associated with at least a second individual operation 220 may include at least one additional operation. Additional operations may include an operation 1802, and/or an operation 1804.

At the operation 1802, data including at least one mental disability may be received. For example, as shown in FIG. 1, disability data receiver module 104 may receive data including at least one mental disability. In one specific instance, disability data receiver module 104 receives from memory device 124 data including at least one mental disability. A mental disability may include a mental impairment that limits one or more major life activities of the person with the mental impairment. Examples of a mental disability and/or a mental impairment may include depression, mania, bipolar disorder, mental retardation, learning difficulty, mood disorders, anxiety disorders, psychotic disorders, eating disorders, personality disorders, as well as many other disabilites. In some instances, disability data receiver module 104 may include a computer processor.

At the operation 1804, data including at least one physical disability may be received. For example, as shown in FIG. 1, disability data receiver module 104 may receive data including at least one physical disability. In a specific instance, disability data receiver module 104 receives from compact disc storage 128 data including a physical disability. A physical disability may include physical impairment, sensory impairment, chronic disease, as well as other impairment to body structure and/or impairment to body function. In some instances, disability data receiver module 104 may include a computer processor.

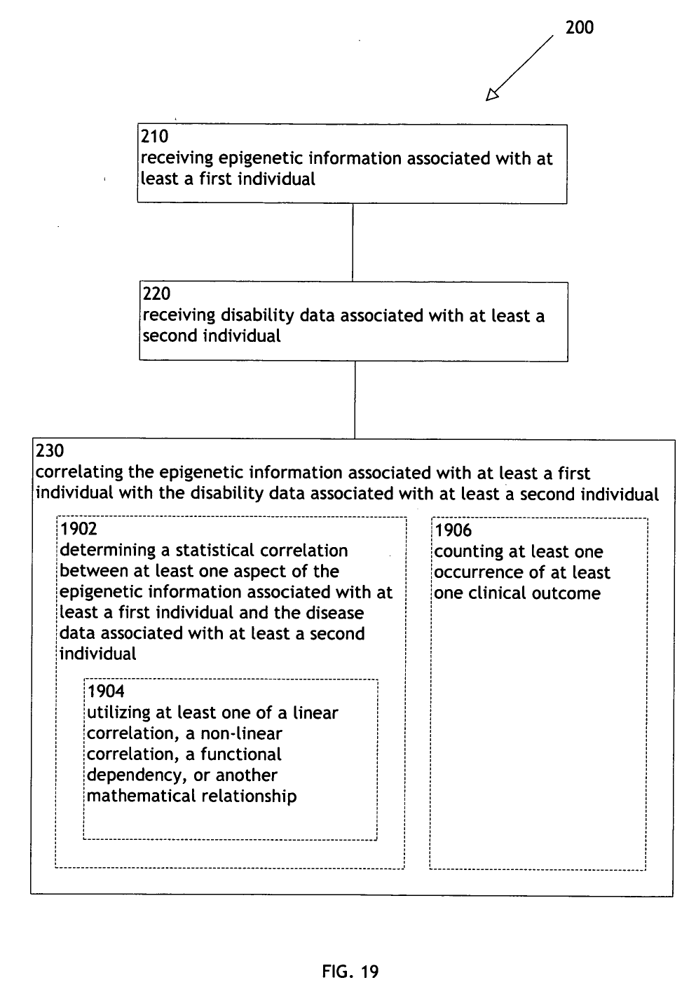

FIG. 19 illustrates alternative embodiments of the example operational flow 200 of FIG. 2. FIG. 19 illustrates example embodiments where the correlating the epigenetic information associated with at least a first individual with the disability data associated with at least a second individual operation 230 may include at least one additional operation. Additional operations may include an operation 1902, an operation 1904, and/or an operation 1906.

At the operation 1902, a statistical correlation between at least one aspect of the epigenetic information associated with at least a first individual and the disease data associated with at least a second individual may be determined. For example, as shown in FIG. 1, determiner module 108 may establish a statistical correlation between at least one aspect of the epigenetic information associated with at least a first individual and the disease data associated with at least a second individual. In one instance, determiner module 108 establishes a statistical correlation between an aspect of the epigenetic information associated with a first individual named William Jones and disease data associated with a second individual named Mitchell Jones. A statistical correlation may indicate the strength and direction of a linear relationship between two variables, such as epigenetic information data and/or disability data. The epigenetic information and/or the disease data may be associated with multiple individuals. In some instances, determiner module 108 may include a computer processor. Further, at the operation 1904, at least one of a linear correlation, a non-linear correlation, a functional dependency, or another mathematical relationship may be utilized. For example, as shown in FIG. 1, utilizer module 110 may apply at least one of a linear correlation, a non-linear correlation, a functional dependency, or another mathematical relationship. In one specific instance, utilizer module 110 applies a linear correlation between epigenetic information data and disability data for determining whether a specific histone modification indicates a likelihood of developing a certain medical condition, such as cirrhosis. A linear correlation may include a relationship between variables where the changes in one variable are proportional to changes in the other variable. A non-linear correlation may include a relationship between variables where the changes in one variable are not proportional to changes in the other variable. A functional dependency may exist when one variable is fully determined by another variable. In some instances, utilizer module 110 may include a computer processor.

At the operation 1906, at least one occurrence of at least one clinical outcome may be counted. For example, as shown in FIG. 1, counter module 112 may calculate at least one occurrence of at least one clinical outcome. In a specific example, counter module 112 calculates an occurrence of at least one clinical outcome, such as a gene mutation. Counting an occurrence of at least one clinical outcome may include counting a single occurrence of an outcome, such as, for example, a genomic imprinting, a gene mutation, and/or a certain phenotype. In some instances, counter module 112 may include a computer processor.

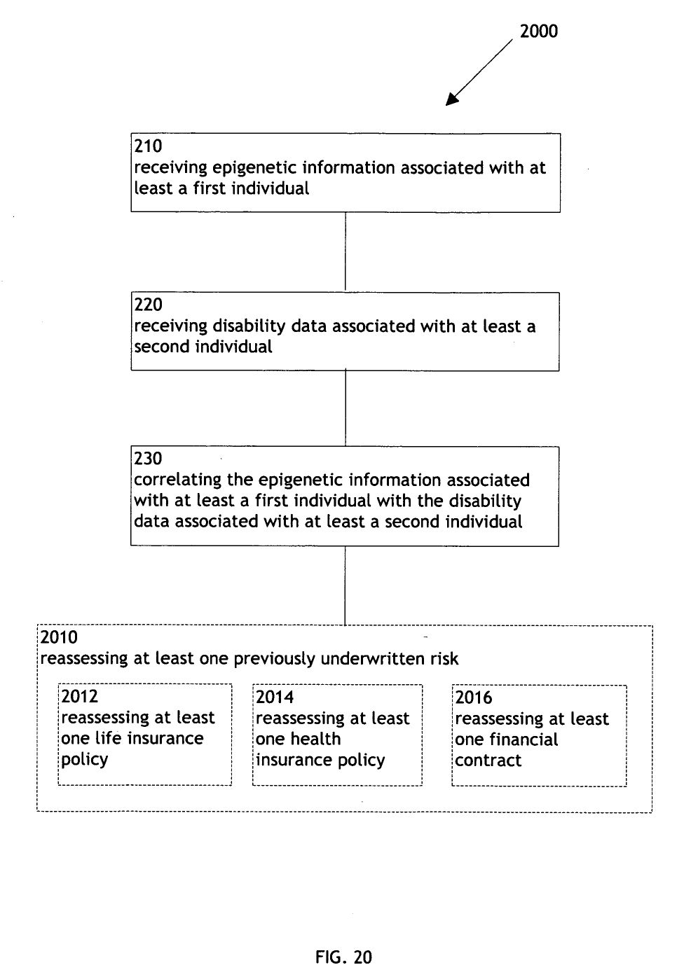

FIG. 20 illustrates an operational flow 2000 representing example operations related to receiving epigenetic information associated with at least a first individual, receiving disability data associated with at least a second individual, correlating the epigenetic information associated with at least a first individual with the disability data associated with at least a second individual, and/or reassessing at least one previously underwritten risk. FIG. 20 illustrates an example embodiment where the example operational flow 200 of FIG. 2 may include at least one additional operation. Additional operations may include an operation 2010, an operation 2012, an operation 2014, and/or an operation 2016.

After a start operation, a receiving epigenetic information associated with at least a first individual operation 210, a receiving disability data associated with at least a second individual operation 220, and a correlating the epigenetic information associated with at least a first individual with the disability data associated with at least a second individual operation 230, the operational flow 2000 may move to a reassessing at least one previously underwritten risk operation 2010, where at least one previously underwritten risk may be reassessed. For example, as shown in FIG. 1, reassessor module 114 may reevaluate at least one previously underwritten risk. In one specific example, reassessor module 114 reevaluates at least one previously underwritten risk. In some instances, reassessor module 114 may include a computer processor.

At the operation 2012, at least one life insurance policy may be reassessed. For example, as shown in FIG. 1, reassessor module 114 may reassess at least one life insurance policy. In one specific example, reassessor module 114 reevaluates a group of five hundred life insurance policies. A life insurance policy may include a reinsurance policy. In some instances, reassessor module 114 may include a computer processor.

At the operation 2014, at least one health insurance policy may be reassessed. For example, as shown in FIG. 1, reassessor module 114 may reassess a health insurance policy. In one specific example, reassessor module 114 reevaluates a health insurance policy. Additionally, multiple health insurance policies may be reassessed. A health insurance policy may include a reinsurance policy. In some instances, reassessor module 114 may include a computer processor.

At the operation 2016, at least one financial contract may be reassessed. For example, as shown in FIG. 1, reassessor module 114 may reassess a financial contract. In one specific instance, reassessor module 114 reassesses a financial contract. A financial contract may include an annuity, a bond, and/or a loans. In some instances, reassessor module 114 may include a computer processor.

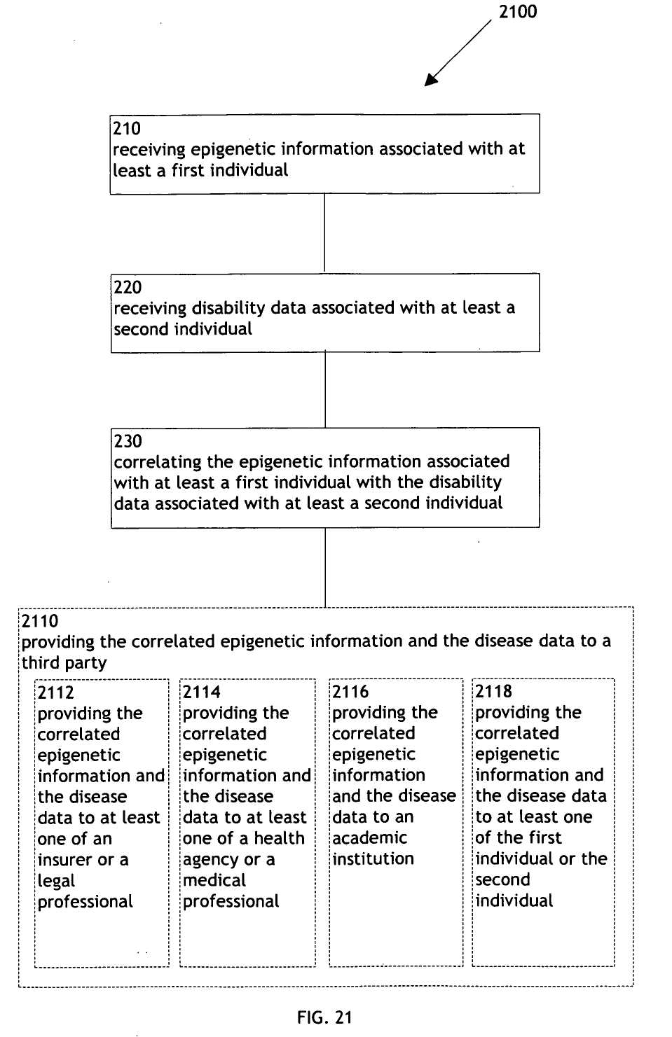

FIG. 21 illustrates an operational flow 2100 representing example operations related to receiving epigenetic information associated with at least a first individual, receiving disability data associated with at least a second individual, correlating the epigenetic information associated with at least a first individual with the disability data associated with at least a second individual, and/or providing the correlated epigenetic information and the disease data to a third party. FIG. 21 illustrates an example embodiment where the example operational flow 200 of FIG. 2 may include at least one additional operation. Additional operations may include an operation 2110, an operation 2112, an operation 2114, an operation 2116 and/or an operation 2118.

After a start operation, a receiving epigenetic information associated with at least a first individual operation 210, a receiving disability data associated with at least a second individual operation 220, and a correlating the epigenetic information associated with at least a first individual with the disability data associated with at least a second individual operation 230, the operational flow 2100 may move to a providing the correlated epigenetic information and the disease data to a third party operation 2110, where the correlated epigenetic information and the disease data to a third party may be provided. For example, as shown in FIG. 1, the provider module 116 supply the correlated epigenetic information and the disease data to a third party. In a specific example, provider module 116 supplies the correlated epigenetic information and the disease data to a third party. A third party may include a person who is not a party to a contract or situation but may become involved in an indirect way or be affected by it. In some instances, provider module 116 may include a computer processor.

At the operation 2112, the correlated epigenetic information and the disease data may be provided to at least one of an insurer or a legal professional. For example, as shown in FIG. 1, provider module 116 may supply the correlated epigenetic information and the disease data to at least one of an insurer or a legal professional. In one specific instance, provider module 116 supplies the correlated epigenetic information and the disease data to an insurer. In another specific instance, provider module 116 supplies the correlated epigenetic information and the disease data to a legal professional. An insurer may include a company or an entity that issues a contract for insurance, including health insurance, life insurance, disability insurance, and/or other types of insurance. A legal professional may include an attorney, a paralegal, a law firm, an in-house counsel, a contractor or other entity hired by a legal professional, and/or other entities dealing with the practice or enforcing the law. In some instances, provider module 116 may include a computer processor.

At the operation 2114, the correlated epigenetic information and the disease data may be provided to at least one of a health agency or a medical professional. For example, as shown in FIG. 1, provider module 116 may supply the correlated epigenetic information and the disease data to at least one of a health agency or a medical professional. In one specific instance, provider module 116 supplies the correlated epigenetic information and the disease data to a health agency. In another specific instance, provider module 116 supplies the correlated epigenetic information and the disease data to a medical professional. A health agency may include any governmental unit, business, and/or other entity that relates to health. A medical professional may include a physician, a nurse, a pharmacist, a physical therapist, a hospital administrator and/or administration staff, an entity hired/employed by a medical professional, and/or other entities dealing with practicing and/or providing medical care. In some instances, provider module 116 may include a computer processor.

At the operation 2116, the correlated epigenetic information and the disease data may be provided to an academic institution. For example, as shown in FIG. 1, provider module 116 may supply the correlated epigenetic information and the disease data to an academic institution. In one specific example, provider module 116 supplies the correlated epigenetic information and the disease data to an academic institution. An academic institution may include a public and/or private educational institution, which may grant academic degrees. In some instances, provider module 116 may include a computer processor.

At the operation 2118, the correlated epigenetic information and the disease data may be provided to at least one of the first individual or the second individual. For example, as shown in FIG. 1, provider module 116 may supply the correlated epigenetic information and the disease data to at least one of the first individual or the second individual. In one specific example, provider module 116 supplies the correlated epigenetic information and the disease data to the first individual. In another specific example, provider module 116 supplies the correlated epigenetic information and the disease data to the second individual. The first individual and/or the second individual may include multiple individuals. In some instances, provider module 116 may include a computer processor.

Those having skill in the art wilt recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art wilt recognize that optical aspects of implementations wilt typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more”or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method, comprising:
receiving epigenetic information associated with at least a first individual;
receiving disability data associated with at least a second individual; and
correlating the epigenetic information associated with at least a first individual with the disability data associated with at least a second individual.

2-52. (canceled)

53. A system, comprising:
means for receiving epigenetic information associated with at least a first individual;
means for receiving disability data associated with at least a second individual; and
means for correlating the epigenetic information associated with at least a first individual with the disability data associated with at least a second individual.

54. The system of claim 53, wherein means for receiving epigenetic information associated with at least a first individual comprises:
means for receiving epigenetic information associated with at least a first individual in the form of a database.

55. The system of claim 53, wherein means for receiving epigenetic information associated with at least a first individual comprises:
means for receiving a first set of epigenetic information associated with at least a first individual; and
means for receiving a second set of epigenetic information associated with at least a first individual.

56. The system of claim 55, further comprising:
means for receiving a third set of epigenetic information associated with at least a first individual.

57. The system of claim 53, wherein means for receiving epigenetic information associated with at least a first individual comprises:
means for receiving information including a cytosine methylation status of CpG positions.

58. The system of claim 53, wherein means for receiving epigenetic information associated with at least a first individual comprises:
means for receiving information including histone modification status.

59. The system of claim 53, wherein means for receiving epigenetic information associated with at least a first individual comprises:
means for receiving epigenetic information associated with at least a first individual on a subscription basis.

60. The system of claim 53, wherein means for receiving epigenetic information associated with at least a first individual comprises:
means for receiving anonymized epigenetic information associated with at least a first individual.

61. The system of claim 60, wherein means for receiving anonymized epigenetic information associated with at least a first individual comprises:
means for receiving epigenetic information for at least an other individual in the form of a database.

62. The system of claim 60, wherein means for receiving anonymized epigenetic information associated with at least a first individual comprises:
means for receiving a first set of epigenetic information for at least an other individual; and
means for receiving a second set of epigenetic information for at least an other individual.

63. The system of claim 62, further comprising:
means for receiving a third set of epigenetic information for at least an other individual.

64. The system of claim 60, wherein means for receiving anonymized epigenetic information associated with at least a first individual comprises:
means for receiving information for at least an other individual including a cytosine methylation status of CpG positions.

65. The system of claim 60, wherein means for receiving anonymized epigenetic information associated with at least a first individual comprises:
means for receiving information for at least an other individual including histone modification status.

66. The system of claim 60, wherein means for receiving anonymized epigenetic information associated with at least a first individual comprises:
means for receiving for at least an other individual epigenetic information on a subscription basis.

67. The system of claim 53, wherein means for receiving disability data associated with at least a second individual comprises:
means for receiving a set of disease data associated with at least a second individual.

68. The system of claim 67, wherein means for receiving a set of disease data associated with at least a second individual comprises:
means for receiving a set of disease data associated with at least a second individual in the form of a database.

69. The system of claim 67, wherein means for receiving a set of disease data associated with at least a second individual comprises:
means for receiving a set of disease data associated with at least a second individual for a plurality of individuals including at least the first individual and the second individual.

70. The system of claim 67, wherein means for receiving a set of disease data associated with at least a second individual comprises:
means for receiving a first set of disease data associated with at least a second individual; and
means for receiving a second set of disease data associated with at least a second individual.

71. The system of claim 70, further comprising:
means for receiving a third set of disease data associated with at least a second individual.

72. The system of claim 67, wherein means for receiving a set of disease data associated with at least a second individual comprises:
means for receiving disease data associated with at least a second individual on a subscription basis.

73. The system of claim 67, wherein means for receiving a set of disease data associated with at least a second individual comprises:
means for receiving anonymized disease data associated with at least a second individual.

74. (canceled)

75. The system of claim 73, wherein means for receiving anonymized disease data associated with at least a second individual comprises:
means for receiving for at least an other individual a first set of disease data; and
means for receiving for at least an other individual a second set of disease data.

76. The system of claim 75, further comprising:
means for receiving for at least an other individual a third set of disease data.

77. The system of claim 73, wherein means for receiving anonymized disease data associated with at least a second individual comprises:
means for receiving information including a cytosine methylation status of CpG positions for at least a second individual.

78. The system of claim 73, wherein means for receiving anonymized disease data associated with at least a second individual comprises:
means for receiving information including histone modification status for at least a second individual.

79. The system of claim 73, wherein means for receiving anonymized disease data associated with at least a second individual comprises:
means for receiving anonymized disease data associated with at least a second individual on a subscription basis.

80. The system of claim 67, wherein means for receiving a set of disease data associated with at least a second individual comprises:
means for receiving public health information.

81-89. (canceled)

90. The system of claim 53, wherein means for receiving disability data associated with at least a second individual comprises:
means for receiving data including at least one emotional disability.

91. The system of claim 53, wherein means for receiving disability data associated with at least a second individual comprises:
means for receiving data including at least one mental disability.

92. The system of claim 53, wherein means for receiving disability data associated with at least a second individual comprises:
means for receiving data including at least one physical disability.

93. The system of claim 53, wherein means for correlating the epigenetic information associated with at least a first individual with the disability data associated with at least a second individual comprises:
means for determining a statistical correlation between at least one aspect of the epigenetic information associated with at least a first individual and the disease data associated with at least a second individual.

94. The system of claim 93, wherein means for determining a statistical correlation between at least one aspect of the epigenetic information associated with at least a first individual and the disease data associated with at least a second individual comprises:
means for utilizing at least one of a linear correlation, a non-linear correlation, a functional dependency, or another mathematical relationship.

95. The system of claim 53, wherein means for correlating the epigenetic information associated with at least a first individual with the disability data associated with at least a second individual comprises:
means for counting at least one occurrence of at least one clinical outcome.

96. The system of claim 53, further comprising:
means for reassessing at least one previously underwritten risk.

97-99. (canceled)

100. The system of claim 53, further comprising:
means for providing the correlated epigenetic information and the disease data to a third party.

101-104. (canceled)

105. A system, comprising:
circuitry for receiving epigenetic information associated with at least a first individual;
circuitry for receiving disability data associated with at least a second individual; and
circuitry for correlating the epigenetic information associated with at least a first individual with the disability data associated with at least a second individual.
